(19) United States
(12) Patent Application Publication
(10) Pub. No.: US 2019/0126753 A1
(43) Pub. Date: May 2, 2019

(54) MULTI-PIECE DASH MOUNT BRAKE CONTROLLER

(71) Applicant: HORIZON GLOBAL AMERICAS INC., Plymouth, MI (US)

(72) Inventors: Chandrakumar D. Kulkarni, Battle Creek, MI (US); Muthukumar Jegadeeson, Novi, MI (US); Fred Brickley, Plymouth, MI (US)

(21) Appl. No.: 16/173,433

(22) Filed: Oct. 29, 2018

Related U.S. Application Data
(60) Provisional application No. 62/578,014, filed on Oct. 27, 2017.

(51) Int. Cl. B60K 37/02; B60T 17/22; B60T 7/08; B60T 7/20; B60T 8/32; B60T 8/172; B60K 35/00; B60K 37/06

(52) U.S. Cl. CPC B60K 37/02; B60T 17/22; B60T 7/085; B60K 37/06; B60T 8/323; B60T 8/172; B60K 35/00; B60T 7/20

(57) ABSTRACT

A brake control unit includes an under dash unit and a dash mount unit. The dash mount unit is mounted to a dashboard of a vehicle and includes an accelerometer. The dash mount unit also includes a display and an input device. The under dash unit is positioned in another location of the vehicle and is communicatively coupled to the dash mount unit.

### CROSS-REFERENCE TO RELATED APPLICATION

This application claims priority to U.S. Provisional Patent Application No. 62/578,014 entitled “MULTI-PIECE DASH MOUNT BRAKE CONTROLLER,” filed on Oct. 27, 2017, which is incorporated herein by reference in its entirety.

### FIELD OF THE INVENTION

The present invention relates generally to brake control units, and more specifically, to a multi-piece brake control unit having a single dash mounted display and control.

### BACKGROUND OF THE INVENTION

A variety of prior art brake control units that provide a brake output signal to the brakes of a towed vehicle have been proposed and/or manufactured. One example of such a brake control unit is provided by U.S. Pat. No. 8,746,812 which is incorporated by reference in its entirety.

Most traditional brake control units are not integral with the towing vehicle's instrument panel. They are aftermarket units which are mounted to a vehicle. Such brake controls in the past were mounted on the dash as a one piece assembly or as a two piece assembly. These brake controls could not be mounted in a random direction, which can be an issue. Some two piece assemblies had limited abilities on displays and interfaces. They required mounting the display, accelerometer unit, and interfaces (e.g., the manual activation) in the cab of a vehicle. The position of each of these was limited and took up space in the cab. They also used a push button for manual activation which could result in full output. The gain and boost could not be easily adjusted with the two piece control due to the limited display.

In further view of these and other shortcomings, there is a need for an improved brake control unit that provides for flexibility in mounting, improved controls, efficient management of space, and the like.

### SUMMARY OF THE INVENTION

A disclosed brake control unit includes a dash mount unit A brake control unit for controlling brakes of a towed vehicle comprises a dash mount unit comprising: a body comprising an accelerometer and a processor; an input device extending from the body; and a display device disposed within the input device; and an under dash mount unit communicatively coupled to the dash mount unit and comprising a main control board, wherein the under dash mount unit is separate from the body of the dash mount unit. The input device may comprise a hollow shaft potentiometer. The input device may further comprise the hollow shaft potentiometer and a control knob, and wherein the hollow shaft potentiometer is mounted with the control knob. The display device is positioned within the control knob. The display device may comprise a dual 7-segment display. The control knob may comprise a lens positioned in front of the display device. The control knob may comprise a sensor that operatively detects a push of the control knob representing input from a user. The control knob may comprise a sensor that operatively detects a turn of the control knob representing input from a user. The dash mount unit may comprise a dash mount circuit board, and wherein the accelerometer, the processor, the display, and the input device are coupled to the dash mount circuit board. The dash mount unit may be coupled to the under dash mount unit via at least one of a serial peripheral interface bus or an Inter-Integrated Circuit bus. The dash mount unit and the under dash mount unit may communicate via an encoded pulse width modulated signal. In another aspect, the main control board may a power circuit that operatively sends power to trailer brakes. The power circuit may comprise a main MOSFET and a power MOSFET in series with the main MOSFET. The power MOSFET may be switched to an off condition in response to detection of a short, improper connection, or improper gate voltage.

A disclosed brake control unit comprises a dash mount unit comprising a body comprising an accelerometer and a processor; an input device comprising a hollow shaft potentiometer and a control knob extending from the body, wherein the control knob is rotatable; and a display device disposed within the control knob; and an under dash mount unit communicatively coupled to the dash mount unit and comprising a main control board, wherein the under dash mount unit is separate from the body of the dash mount unit, and wherein the display device maintains its orientation while the control knob is operatively rotated. The under dash mount unit may be operatively installable in any orientation.

A brake control unit may comprise a dash mount unit comprising a body comprising an accelerometer and a processor; an input device comprising a hollow shaft potentiometer and a control knob extending from the body, wherein the control knob is rotatable; and a display device disposed within the control knob; and an under dash mount unit communicatively coupled to the dash mount unit and comprising a main control board, wherein the main control board comprises a power circuit that operatively sends a control signal to brakes of a towed vehicle, and wherein the main control board determines whether the main control board and the body are in operative communication. The main control board sends the control signal is a proportional control signal when the main control board determines that the main control board and the body are in operative communication. The main control board sends the control signal is a predetermined ramping control signal when the main control board determines that the main control board and the body are not in operative communication. In an example, at least one of the dash mount unit or under dash mount unit operatively enter a sleep mode in response to at least one of a passage of time where manual braking is not activated, gain adjustments are not activated, boost adjustments are not activated, a stoplight is not activated, or an accelerometer readings is inactive. At least one of the dash mount unit or under dash mount unit operatively exits the sleep mode upon activation of manual braking, gain adjustments, boost adjustments, stoplight activation, or accelerometer readings.

These and other features, advantages, and objects of the present invention will be further understood and appreciated by those skilled in the art by reference to the following specification, claims, and appended drawings.

### DESCRIPTION OF THE DRAWINGS

Objects and advantages together with the operation of the present teaching may be better understood by reference to the following detailed description taken in connection with the following illustrations, wherein:

FIG. 1 is a functional schematic diagram of a brake controller system of the present disclosure;

FIG. 2 is a front view of a dash mount unit for a brake control system in accordance with the present disclosure;

FIG. 3 is a perspective view of the dash mount unit of FIG. 1 in accordance with an embodiment of the present disclosure;

FIG. 4 is a front view of the dash mount unit of FIG. 1 in accordance with an embodiment of the present disclosure;

FIG. 5 is a side view of the dash mount unit of FIG. 1 in accordance with an embodiment of the present disclosure;

FIG. 6 is an exploded view of the dash mount unit of FIG. 1 in accordance with an embodiment of the present disclosure;

FIG. 7 is a front left, perspective view of another dash mount unit for a brake control system in accordance with the present disclosure;

FIG. 8 is a schematic diagram of an exemplary display circuit in accordance with the present disclosure;

FIG. 9 is a schematic diagram of a dash mount unit in accordance with the present disclosure;

FIG. 10 is a schematic diagram of an under dash mount unit in accordance with the present disclosure;

FIGS. 11A and 11B are a schematic diagram of a dash mount unit in accordance with the present disclosure;

FIGS. 12A and 12 B are a schematic diagram of an under dash mount unit in accordance with the present disclosure.

### DETAILED DESCRIPTION

Reference will now be made in detail to exemplary embodiments of the present teachings, examples of which are illustrated in the accompanying drawings. It is to be understood that other embodiments may be utilized and structural and functional changes may be made without departing from the respective scope of the present teachings. As such, the following description is presented by way of illustration only and should not limit in any way the various alternatives and modifications that may be made to the illustrated embodiments and still be within the spirit and scope of the present teachings.

As used herein, the words “example” and “exemplary” mean an instance or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

As used herein, a towing vehicle may include various types of automobiles (e.g., car, truck, recreational vehicle (“RV”), etc.). A towed vehicle may include trailers (e.g., agricultural trails, boat trailers, etc.), an automobile, or the like. It is noted that various combinations of towed vehicles and towing vehicles may utilize some or all aspects of this disclosure.

Disclosed embodiments may refer to a brake controller, brake controller device, or the like. Such terms are used interchangeably to describe electronic devices that control the brakes of a trailer or towed vehicle. For instance, a brake controller may comprise a unit that is mounted in or on a towing vehicle. The towing vehicle is attached to a towed vehicle (e.g., via a hitch or the like). The towing vehicle may pull, push, or otherwise tow the towed vehicle. The brake controller system may monitor acceleration and application of a brake pedal to control the brakes of the towed vehicle to operatively apply (e.g., engage, release, etc.) the towed vehicle brakes. Moreover, while embodiments may refer to a brake controller system comprising various components, such components may be a single device or multiple devices in communication with each other. For example, a brake controller may include a display, a processing unit, and an accelerometer. These components may be comprised within a single housing or in multiple housings. The components may include wiring, circuitry, or the like. In at least one embodiment, a brake controller may be mounted in or on a towing or towed vehicle. Other components may include anti-sway devices, converters, trailer breakaway systems, tire pressure monitoring systems for trailers, vehicle speed monitoring systems, user equipment devices, internet or network connected devices, external cameras, and the like.

In an aspect, a brake control system for a towed vehicle, e.g., a trailer, is described herein. The brake control system may include a brake control unit that generates an output signal to the brakes of the towed vehicle to apply a certain brake load thereto. The output signal may be related to a variety of input signals received by the brake control unit from the towing vehicle, the towed vehicle, the operator, or any combination of the three. Additionally, the brake control unit may have the capability of providing diagnostic information related to the existence of a short or fault located within the electrical system of the towed and towing vehicles. Additionally, the brake control system may have the capability of providing diagnostic information related to the location of the short or fault and whether the short or fault is located within the electrical system of the towed and towing vehicles or within the brake control unit. This information can assist an operator or a service technician in diagnosing a location of the fault or short within the system. In another aspect, the brake control system may monitor communication between the dash mount unit and the under dash mount unit, and may determine whether communication is lost or interrupted. In the event of interrupted communication, the brake control system may enter a “timer mode” where the under dash mount unit operatively controls the brakes similar to a timer-style brake controller where output to the brakes is ramped according to a predetermined braking pattern. This is because the accelerometer readings are not available to the under dash mount unit due to failure of communication.

The present brake control unit can be an original equipment manufactured (OEM) unit that is installed in the towing vehicle at the factory. Alternatively, the trailer brake control unit can be incorporated into the towing vehicle as an after-market component. The brake control unit can be installed in the dashboard of the towing vehicle, much like a car radio is. In either embodiment, the trailer brake control unit is integrated with the towing vehicle as an electronic control device that provides variable braking power to electric brakes on a vehicle towed by the towing vehicle.

More specifically, the brake control unit generates and applies a particular voltage to the brakes of the towed vehicle so as to apply a brake load to slowdown or stop the towed vehicle. The voltage applied is related to the input signals available on and/or from the towing vehicle, among other available inputs. These additional input signals may come directly from the operator of the towing vehicle, from the towed vehicle, or a combination of any of the three.

The brake control unit may use a variety of preselected or continuously modified algorithms to generate the appropriate output to the towed vehicle brakes based on the received inputs. A processor on the towing vehicle (although it may be located on the towed vehicle or brake control unit) receives the input signals from the source (such as the ABS system, a speed meter, the ignition, the brake pedal, other processors on the towing vehicle, etc.) and generates the appropriate output signal. The algorithms stored within the processor may be updated by having new algorithms entered therein or having the existing algorithms modified automatically or manually. It should be noted that the brake control unit is capable of being reprogrammed, meaning that the algorithms stored therein can be modified by a technician or a completely new set of algorithms may be entered therein by a technician. This allows the brake control unit to be updated with new information regarding the towing vehicle, the towed vehicle, or the brake control unit itself. The algorithms stored in the brake control unit correspond to each unique combination of inputs. The selection of the appropriate algorithm or algorithms is done by the processor once it receives the appropriate input information. Further, depending upon changes in the input(s), the processor may select a different algorithm or algorithms to generate the appropriate brake output signal. Of course, the processor or a technician/operator may alter the algorithms stored to generate an appropriate brake output signal.

The brake output signal controlled by the brake control unit based on information it receives can be represented as a transfer function. It should be understood, however, that the transfer function can include any or all of the input signals listed above in any manner or combination. Additionally, it should be understood that the transfer function is not limited to those input signals listed above. The braking signals produced by the trailer may comprise a pulse width modulation.

Disclosed embodiments may include user interfaces. As used herein, a user interface may include devices that receive input from a user and transmit the input to electronic circuitry, such as a microprocessor, or outputs information to a user. Such user interfaces may include buttons, switches, knobs, touch screens (e.g., capacitive touch screens), microphones, image capturing devices, motion sensors, pressure sensors, a display screen, a speaker, a light (e.g., LED, bulb, etc.), or the like. For brevity, examples may be described with reference to a user interface in general rather than any particular type of user interface. It is noted, however, that brake controllers may include multiple user interfaces of various types.

In some traditional brake controllers the mounting of the brake control was restricted in azimuth. For example, mounting was restricted even in the longitudinal plane in the direction of travel due to display visibility. Many of these controllers did not have a display or separated the display from user controls. Thus, the user would have to interact with multiple parts. The traditional units also did not allow for external parameters such as trailer details, load details, or weather. Moreover, the brake controllers did not communicate with other devices, such as a user's cell phone or other user device (e.g., laptop, wearable electronic device, tablet, GPS device, computer, or the like).

In an aspect, described brake control units may comprise a dash mount unit and a separate unit that may be attached as an under dash mount unit. The dash mount unit may be operatively mounted on a portion of a dash or a cab of a vehicle that faces an operator/driver while the driver is driving. For example, the dash mount unit may be mounted on a control panel near a radio or other controls. The under dash mount may be mounted in any desired location, such as underneath a dash board, in a glove box, behind a dash (e.g., internal to the cab), or the like. In an aspect, the dash mount may comprise an accelerometer, a microcontroller, and an interface devices, such as a display and user controls that may adjust the gain, sensitivity, or manual braking. The dash mount unit may be operatively coupled with the under dash mount unit and may include another processor, power switching circuits, and communication components (e.g., BLUETOOTH) such as through a direct wired connection, through a wireless connection or through the towing vehicle communication system, such as the communication bus of the towing vehicle. In at least one example, the dash mount unit may be coupled to the under dash mount unit via a serial communication or a bus, e.g., a synchronous serial communication interface (an Serial Peripheral Interface bus) or a an Inter-Integrated Circuit (I²C) bus. In at least some examples, an encoded pulse-width modulated signal may be utilized for communication between the dash mount unit and the under dash mount unit, where one unit encodes information into a pulse-width modulated signal to be sent to the other unit, and the receiving unit decodes the information from the encoded pulse-width modulated signal.

In an example, the dash mount unit may include an accelerometer for operatively sensing forces acting on a vehicle. The accelerometer may be housed in the body of the dash mount unit. A control or interface device may extend from the body. Interface devices may include a hollow shaft potentiometer mounted with a control knob. A user may interact with the control knob to adjust brake application settings as described herein. Moreover, the user may utilize the control knob to input information.

It is further noted that the brake control unit may operatively receive information (e.g., trailer details, weather, etc.) from a user device, a network, user input, or the like. Moreover, the brake control unit may transmit information to user devices, a network device, or the like. In an example, the brake control unit may transmit information to a mobile phone. The mobile phone may transmit the information to a network device for performance analysis or the like.

In another example, a brake control unit may include a display in a front control of a dash mount unit along with a knob that allows for continuous manual adjustment. A push button in the center of the knob allows the change of the boost and gain which can be seen on the display. By way of a non-limiting example, the display may be positioned on the knob of the dash mount unit.

The accelerometer that may sense deceleration for proportional output control is mounted on the same board as the potentiometer which goes behind the dash of the car. This allows the control board to be mounted any random orientation. Use of a ‘hollow shaft potentiometer’ allows the use of a dual 7-segment display behind the push button lens. This allows for display of gain and boost, display of diagnostic information like short to ground, open ground, no connection, overload, power loss etc. in one component.

In an example, the display may be located behind push button lens and may be disposed on a display circuit board. The display may be coupled with a display driver, such as a serial display driver with keyscan using I²C or similar 2-wire communication. As described herein, the dash mount unit may include the display, manual potentiometer, accelerometer, display driver and switches. The under dash mount unit may include a control board that includes a processor, communication components (e.g., BLUETOOTH sensors, etc.), and the like. In an aspect, the control board may control the display, manual potentiometer, accelerometer, display driver and switches. The main control board and the display circuit may be coupled together via a communication bus, such as an SPI bus. In an aspect, described brake control units may set gain and boost with a push button, display information through the push button, communicate with other devices (e.g., such as wireless communication with a user device, a wheel speed sensor, etc.), automatically set gain or boost settings, or the like. In an aspect, the boost can be set as a function of a gain setting. Boost may change the transfer function of deceleration to output voltage in a non-linear fashion.

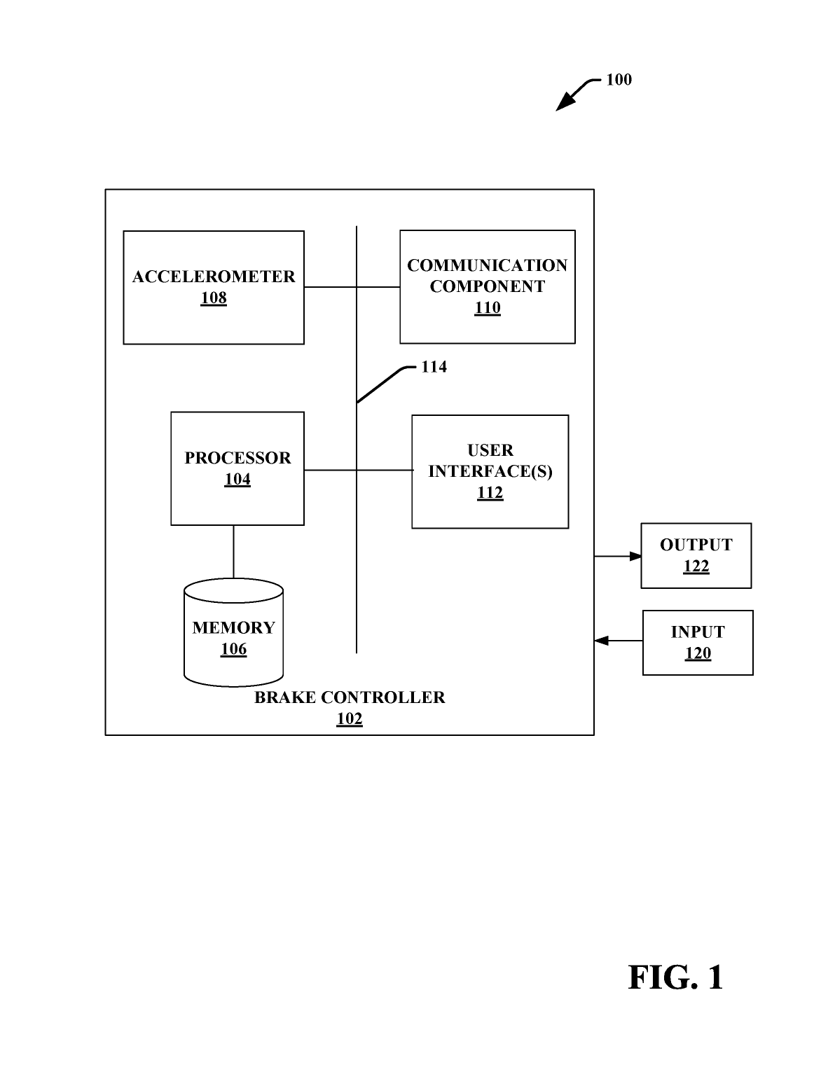

Turning now to FIG. 1, there is a functional block diagram of a brake controller system 100 for controlling trailer brakes of a towed vehicle in accordance with various disclosed embodiments. As described herein, the brake controller system 100 may be a proportional or inertia based system for a towing and towed vehicle system.

Brake controller system 100 may primarily include a processor 104, a memory 106, an accelerometer 108, a communication component 110, user interface(s) 112, and a bus 114 that may electrically couple together the various components. It is noted that memory 102 may store computer executable instructions which may be executed by processor 104. In an aspect, instructions may include control instructions that control or instruct the various components described herein. Furthermore, while embodiments may reference user actions, it is noted that users (e.g., humans, etc.) may not be required to perform such actions. Exemplary, non-limiting brake controller units are disclosed in U.S. Pat. Nos. 6,012,780; 6,068,352; 6,282,480; 6,445,993; 6,615,125; 8,746,812; 8,789,896; and 9,150,201.

The accelerometer 108 may comprise an inertia sensor, such as a single or multi-axis accelerometer (e.g., two-axis, three-axis, etc.), gyroscope, or the like. It is noted that various types of accelerometers may be utilized. While described as a single accelerometer, the accelerometer 108 may comprise multiple accelerometers that may be utilized to measure forces. The accelerometer 108 may comprise circuitry or mechanical components that are responsive to changes in forces, such as changes in acceleration. The accelerometer 108 may be communicated to other components of the brake controller 102 such as the processor 104. For example, the brake controller 102 may be mounted in a cab of a towing vehicle. When the towing vehicle changes its speed and/or travels on a different road grade, the accelerometer 108 may generate an output that represents different values. This output may be received by the processor 104. The output may comprise an electric signal that varies based on the magnitude of acceleration.

User interface(s) 112 may comprise input or output devices as described herein. For example, the user interface(s) 112 may include push buttons, display screen, audio input or output devices, and the like. The user interfaces(s) 112 may be coupled to the processor 104 to communicate information to or from a user. For example, the user interface(s) 112 may include a display that is controlled by the processor 104 to generate output 122 in the form of graphical information. In another instance, the user interface(s) 112 may include push buttons that receive input 120 from a user and transmit the input to 120 to the processor 104 (e.g., manual brake application, sensitivity adjustments, etc.).

Communication component 110 may comprise one or more communication devices that may receive input 120 and transmit output 122. The communication component 110 may comprise hardware, software, and/or a combination of hardware and software. According to embodiments, the communication component 110 may comprise electrical circuitry that facilitates wired or wireless communication. For example, the communication component 110 may comprise a BLUETOOTH® transmitter/receiver. In another example, the communication component 110 may comprise a wire jack, such as an Ethernet connector, USB port, or the like. It is noted that the communication component 110 may include a device that may be disposed within a housing of the brake controller 102 or may be an external device connected to the brake controller 102.

As described herein, the system 100 may include two or more components that are communicatively connected. For instance, the system may include a dash mount unit and an under-dash mount unit. The dash mount unit may include processor 104, memory 106, and the user interfaces 112, such as a display and a knob. The display may be disposed within the knob. The user may interact with the knob and push buttons to adjust the, gain controls, sensitivity controls, and manual brake controls. In an example, the user may press and hold a push button for a period of time. The display may then flash with a code that allows the user to adjust the gain or sensitivity via the knob. In an aspect, the user may cycle between settings by turning the knob and/or pushing the button.

The under-dash mount unit may include another processor, memory, power control circuitry, and a BLUETOOTH communication device. In another aspect, the dash mount unit and under-dash mount unit may both include portions of a component. As an example, the dash mount unit and under-dash mount unit may each comprise portions of the communication component 110.

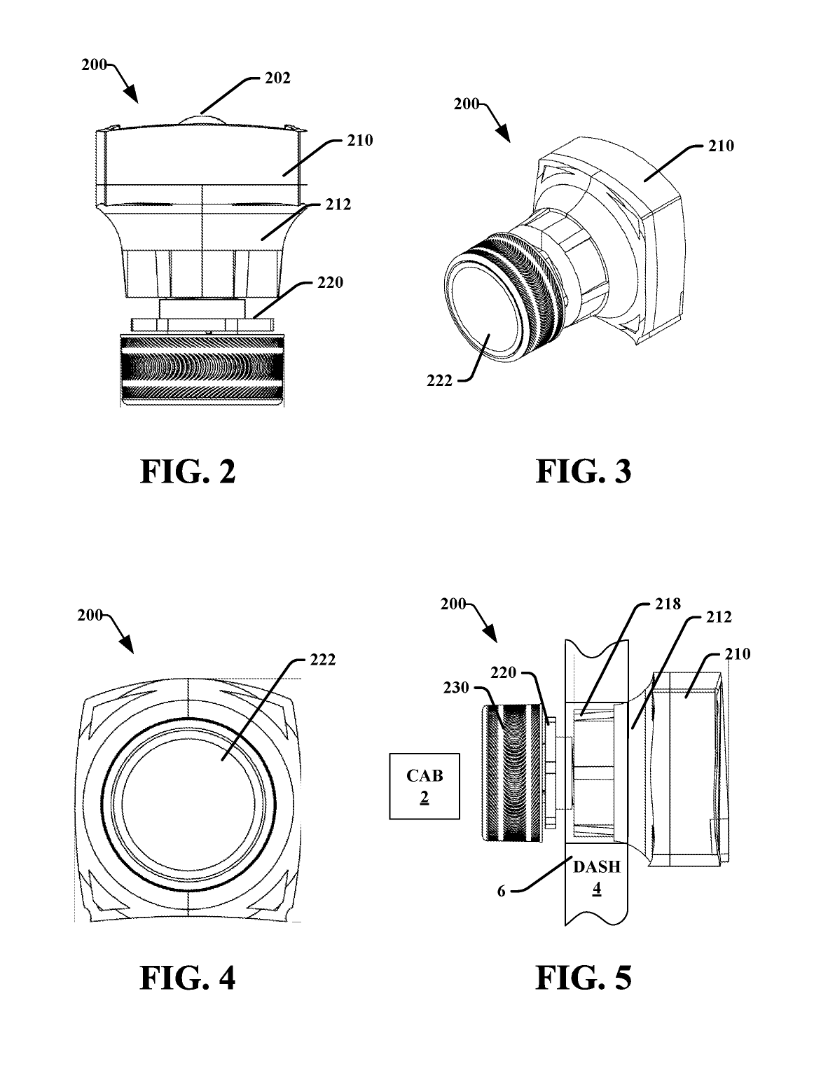

Turning to FIGS. 2-6, there is an exemplary dash mount unit 200 in accordance with various disclosed embodiments. It is noted that the dash mount unit 200 may generally comprise a housing 210, a mount 212, a display board mount 220, an input device 230 and an output device 222. As described herein, the dash mount unit 200 may comprise the processor 106, accelerometer 108 and user interface 112. The dash mount unit 200 may be coupled to an under-dash mount unit as described herein.

In an example shown in FIG. 5, the body 210 may be installed on a dashboard 4 of a towing vehicle. For instance, a hole or aperture 6 may be drilled in a dashboard 4 at an appropriate location. The body 210 may be positioned on the backside of the dashboard 4 and the input device 230 may pass through the aperture 6 to so that the input device 230 is visible and accessible in a cab 2 of a towing vehicle. In at least one aspect, the aperture 6 may be sized and shaped to receive a neck 212 of the body 210. The neck 210 may friction fit with the aperture 6 or may be secured via magnets, fasteners, adhesives, or the like. It is noted that the body 210 may be secured to the dashboard 4 via various other devices or manners.

The body 210 may comprise various materials, such as plastics, metals, or the like. In an aspect, the body 210 houses operative components such as an accelerometer and other circuitry. The body 210 may be sized and shaped to be placed on the backside of the dashboard 4 (e.g., the side opposite the cab 2). It is noted that the space behind the dashboard 4 may be limited and may vary for different vehicles. As such, the body 210 may be relatively compact in comparison to traditional brake controllers. For instance, the body 210 may be generally less than one inch thick and generally less than two inches wide by two inches tall.

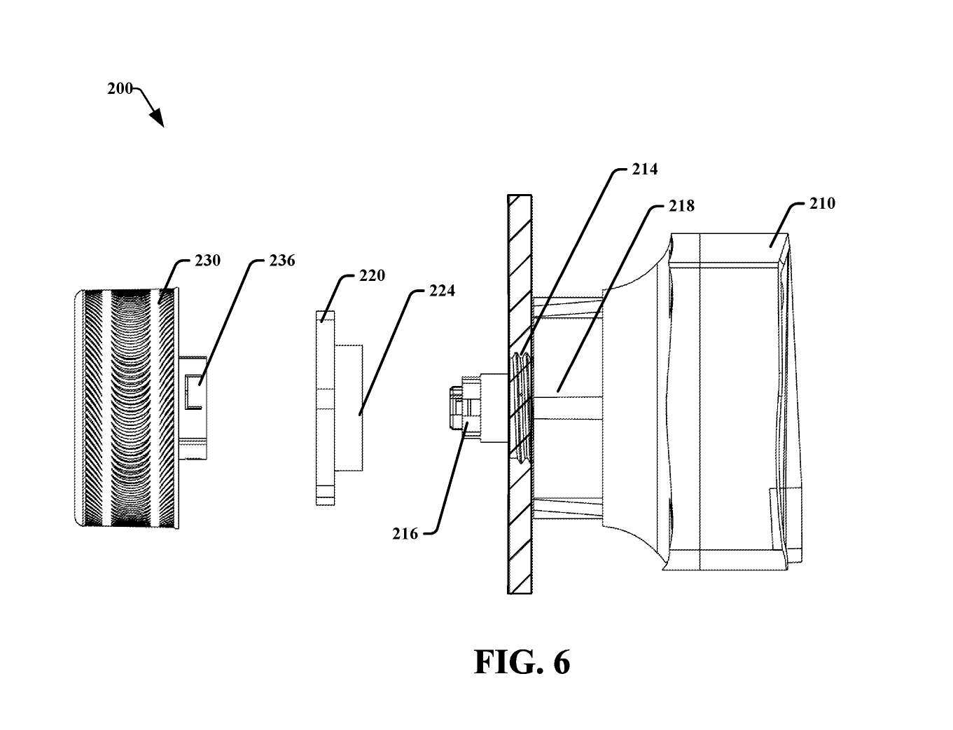

As shown in FIG. 6, the body 210 may include a threaded member 214 that may operatively receive or be threaded with a threaded member 224 of the display board mount or nut 220. In another aspect, the body 210 may include a mount 216 that may operatively attach and secure the interface device 230 via a clip 236. In an aspect, the display board nut 220 may be electrically coupled to circuitry within the body via an electrical connection as described herein. Moreover, the body 210, display board nut 220, and interface device 230 may be connected via other or different mechanisms (e.g., fasteners, hooks, magnets, clips, adhesives, or the like).

The dash mount unit 200 may include a hollow shaft potentiometer 218 (which may be internal to the neck 212 and the body 210). The hollow shaft potentiometer 218 may comprise a rotary position sensor that may allow a user to spin or adjust the interface device 230 (e.g., such as turn the knob). In another aspect, the interface device 230 may be pressed or pushed. This allows the user to interact with the interface device 230 in several ways. Moreover, the display 222 may be visible through the hollow shaft potentiometer 218. In an example, the dash mount unit 200 may allow for displaying of information within a knob so that a user may manually adjust braking parameters and view information (e.g., such as diagnostic information).

Mount 216 may comprise a hollow center that allows for electrical connections to pass from within the body 210 to the display within the knob 230. In an aspect, the mount 216 may include pogo pins passing therethrough.

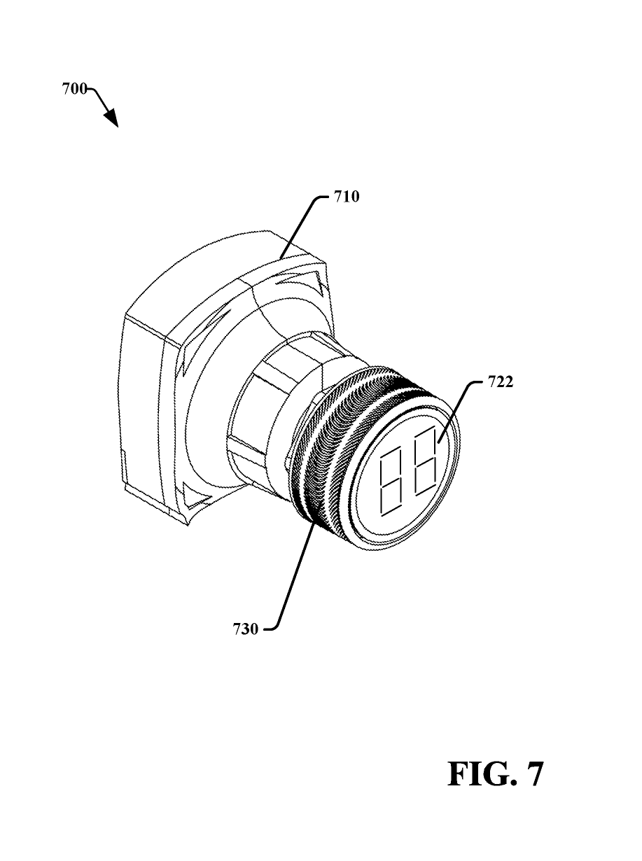

FIG. 7 illustrates a dash mount unit 700 that may comprise a body 710, a knob 730, and a display screen 722. It is noted that the dash mount unit 700 may comprise similar aspects as described with reference to FIGS. 2-8. As can be seen the display screen 722 is operatively mounted to a stationary portion of a hollow shaft potentiometer and is located with the knob 730.

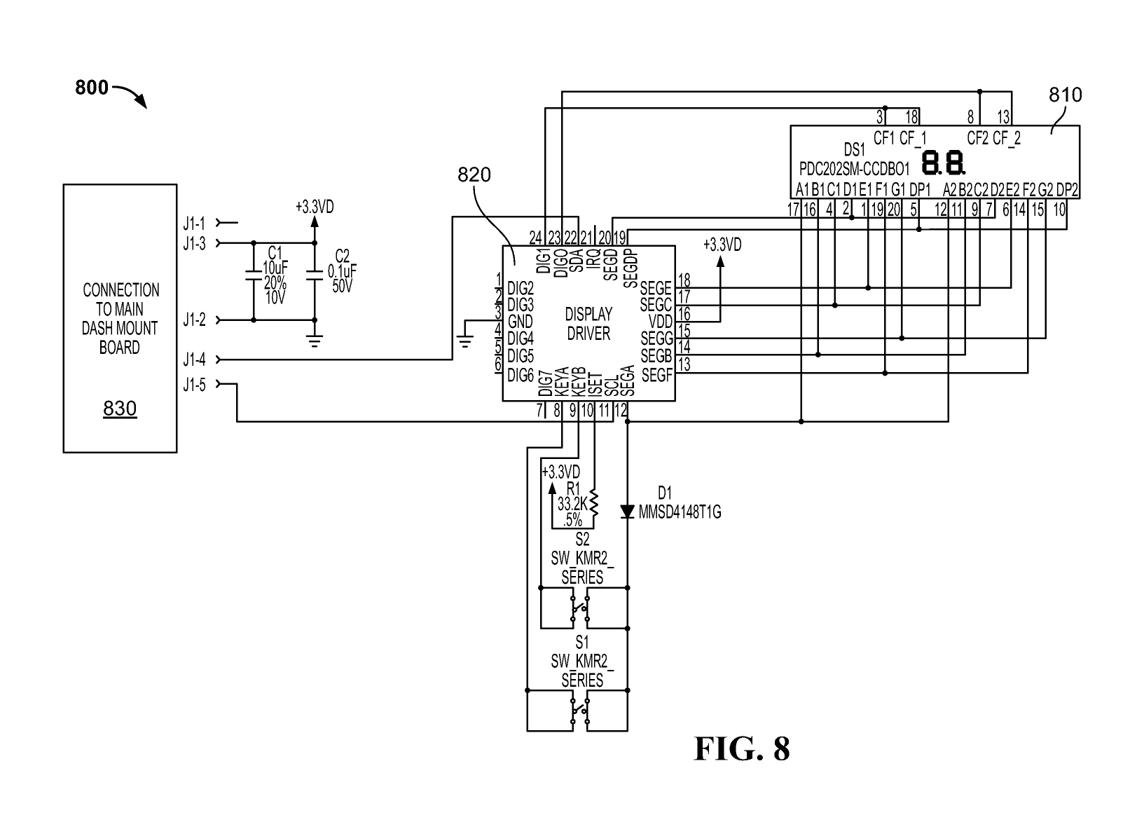

Referring now to FIG. 8, there is a schematic diagram of a display circuit 800 that may be utilized with various disclosed embodiments. In an example, the display circuit 800 may be disposed on a printed circuit board. In an example, the display circuit 800 may be disposed within the input device 230 of FIGS. 2-6. In general, the display circuit 800 may primarily comprise a display 810, a display driver 820, and a connection component 830 (which may electrically connect the display driver 820 to a main dash mount board as described herein). In an example, the display circuit 800 may be disposed on a printed circuit board.

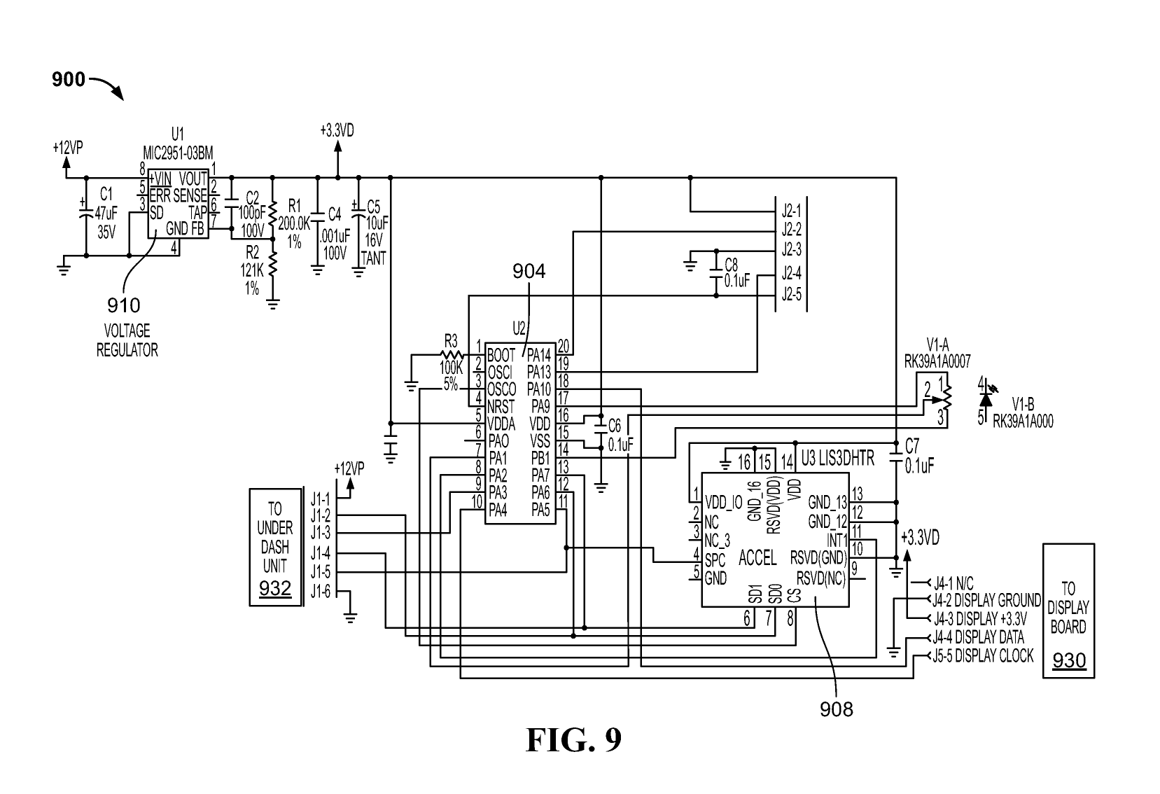

FIG. 9 is a schematic diagram of a dash mount control circuit 900 for a brake control unit in accordance with various disclosed embodiments. The dash mount control circuit 900 may primarily include a microcontroller 904, an accelerometer 908, connection to a display board 930, connection to a display circuit 932, and a voltage regulate 910. The dash mount control circuit 900 may be disposed in the body 210 of FIGS. 2-6 and body 710 of FIG. 7. It is noted that the accelerometer 908 is operatively positioned and secured to an automobile dashboard. As such, other components may be located in any desired location. This allows for flexibility of mounting positions of a main control board. The accelerometer 908 may include a three axis accelerometer. While it may not utilize all three axes, disclosed brake controllers may be configured to determine one or more axis to utilize for braking of a towing vehicle.

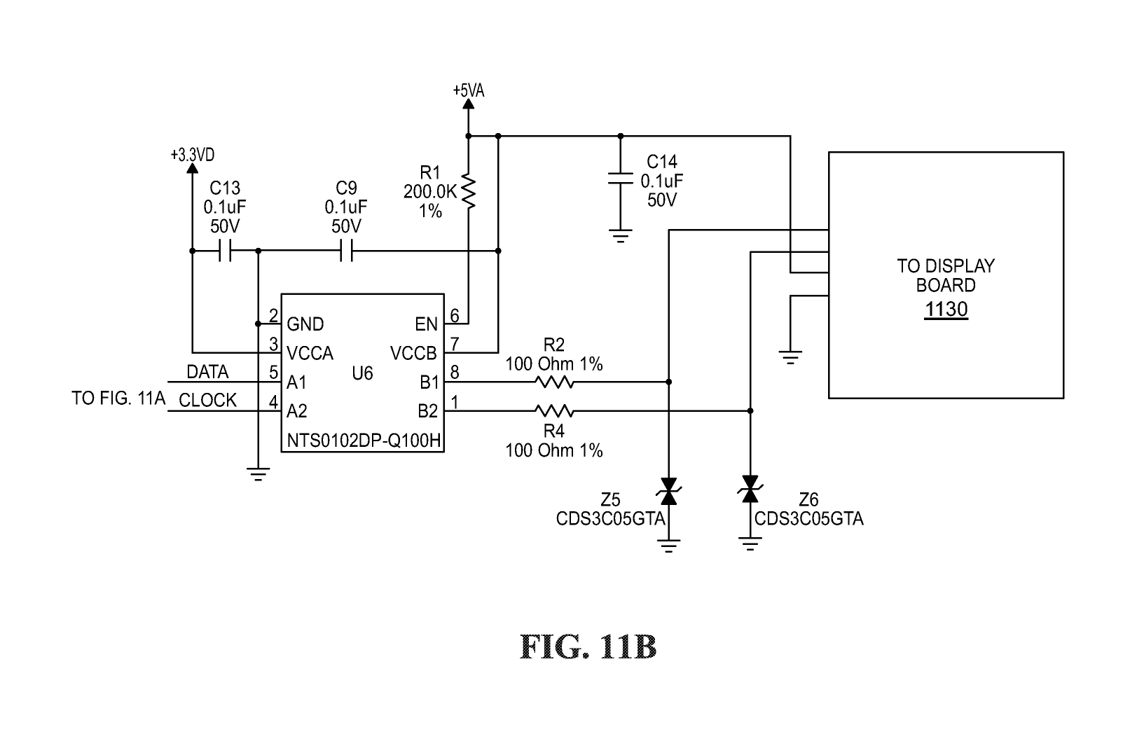

FIGS. 11A and 11B are a schematic diagram of a dash mount control circuit 1100 for a brake control unit in accordance with various disclosed embodiments. The dash mount control circuit 1100 may primarily include a microcontroller 1104, an accelerometer 1108, connection to a display board 1130, connection to a display circuit 1132, and a voltage regulate 1110. The dash mount control circuit 1100 may be disposed in the body 210 of FIGS. 2-6 and body 710 of FIG. 7. It is noted that the accelerometer 1108 is operatively positioned and secured to an automobile dashboard. As such, other components may be located in any desired location. This allows for flexibility of mounting positions of a main control board. The accelerometer 1108 may include a three axis accelerometer. While it may not utilize all three axes, disclosed brake controllers may be configured to determine one or more axis to utilize for braking of a towing vehicle.

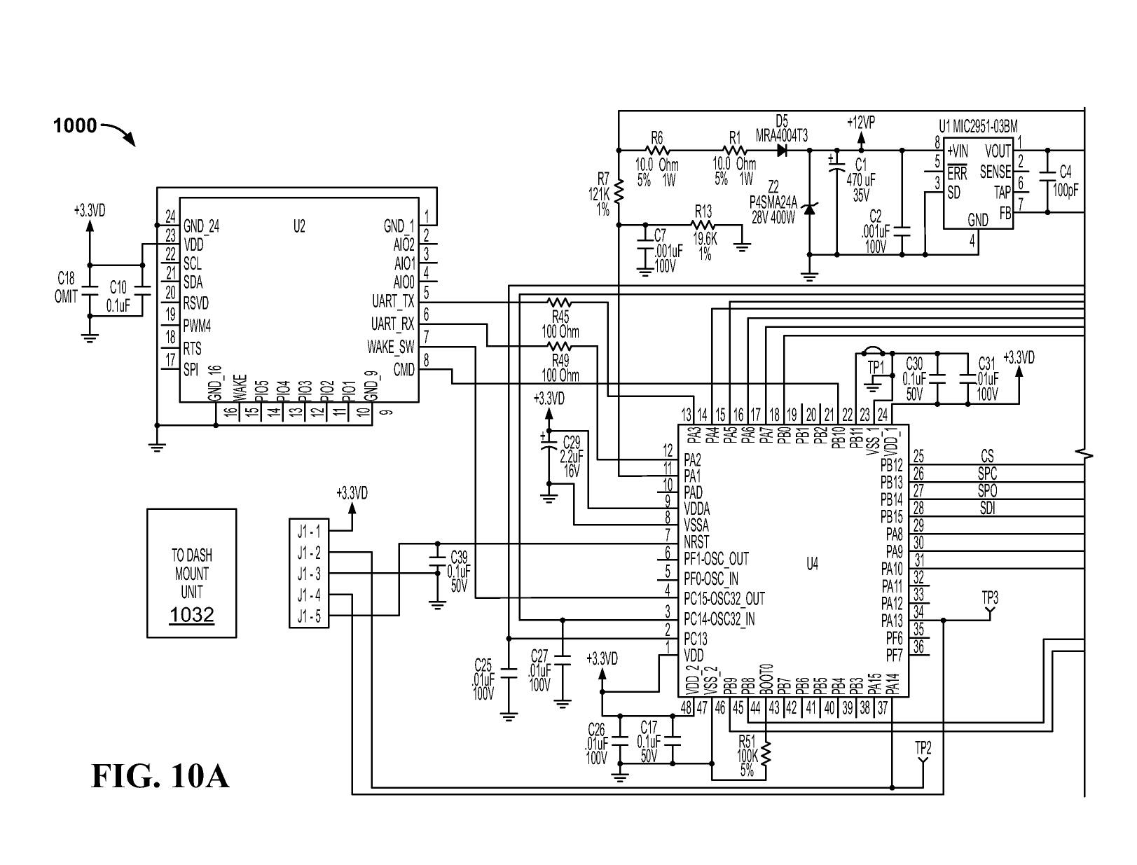

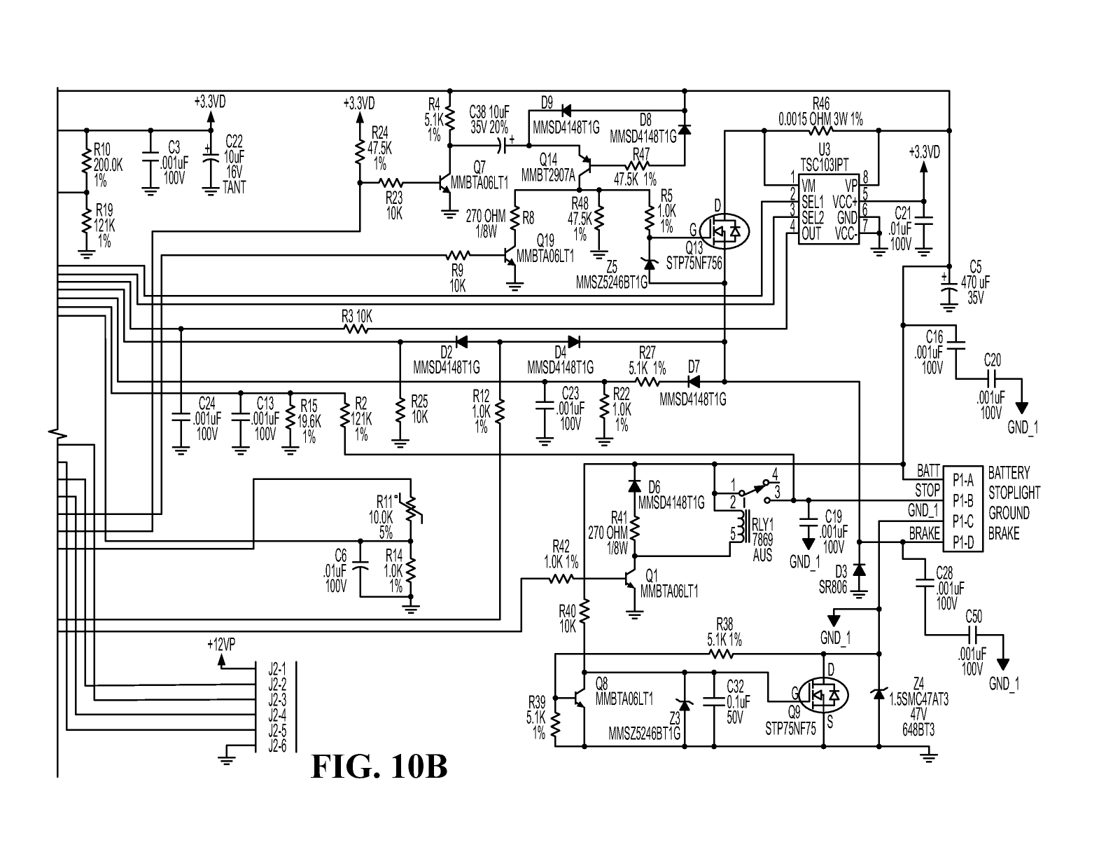

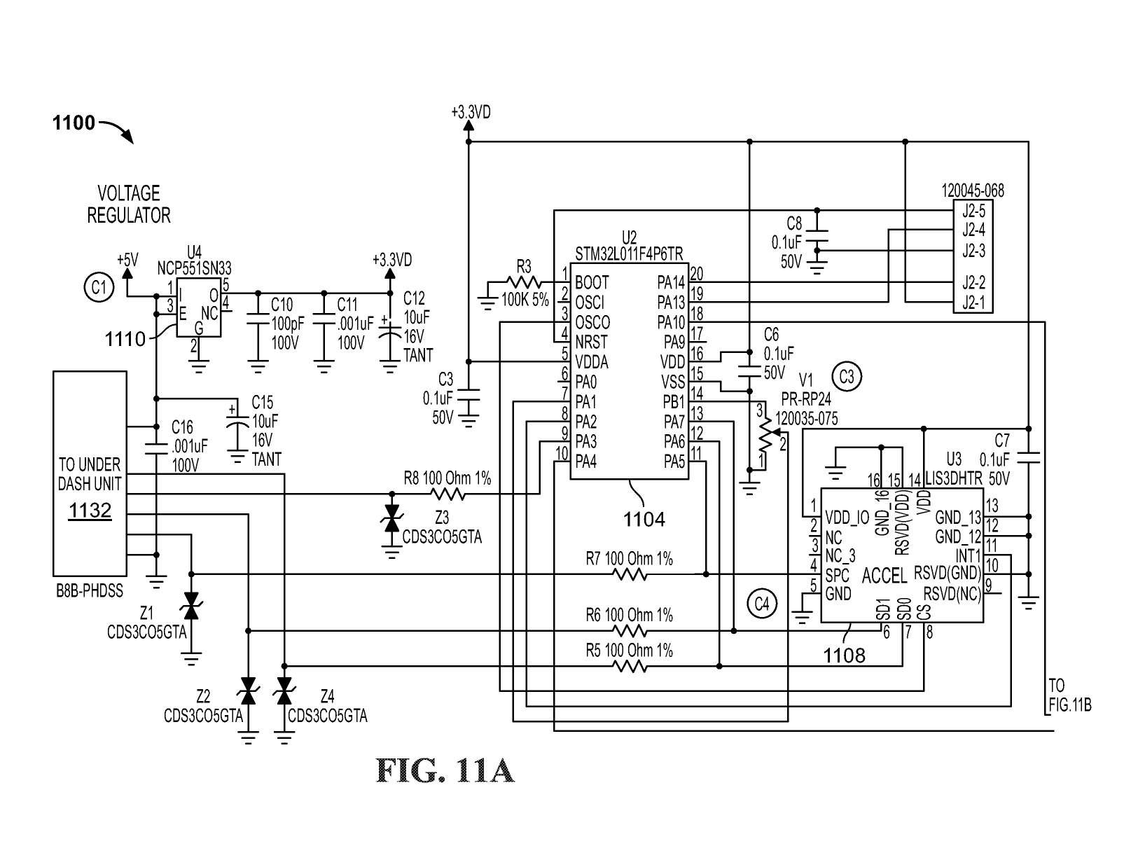

FIG. 10 is a schematic diagram for an under dash mount main control circuit 1000 for a brake control unit in accordance with various disclosed embodiments. The under dash mount control circuit 1000 may be operatively connected a dash mount control circuit (e.g., circuit 900) via connection 1032 in accordance with various disclosed embodiments. It is noted that the main control circuit 1000 may comprise a processor that communicates with the processor of the dash mount unit. In another aspect, the control circuit includes a wireless transponder/receiver and power control circuitry. As the main control circuit 1000 does not include an accelerometer it may be mounted in any desired orientation or position.

As the control circuit 1000 does not include an accelerometer as in tradition systems, the mounting position of the control circuit 1000 is not limited. Moreover, the control circuit 1000 may be disposed in a housing. In various embodiments, the control circuit may be positioned behind the dash on the floor, or any other location that is out of the way and generally hidden. This may improve the aesthetics of the overall design as well.

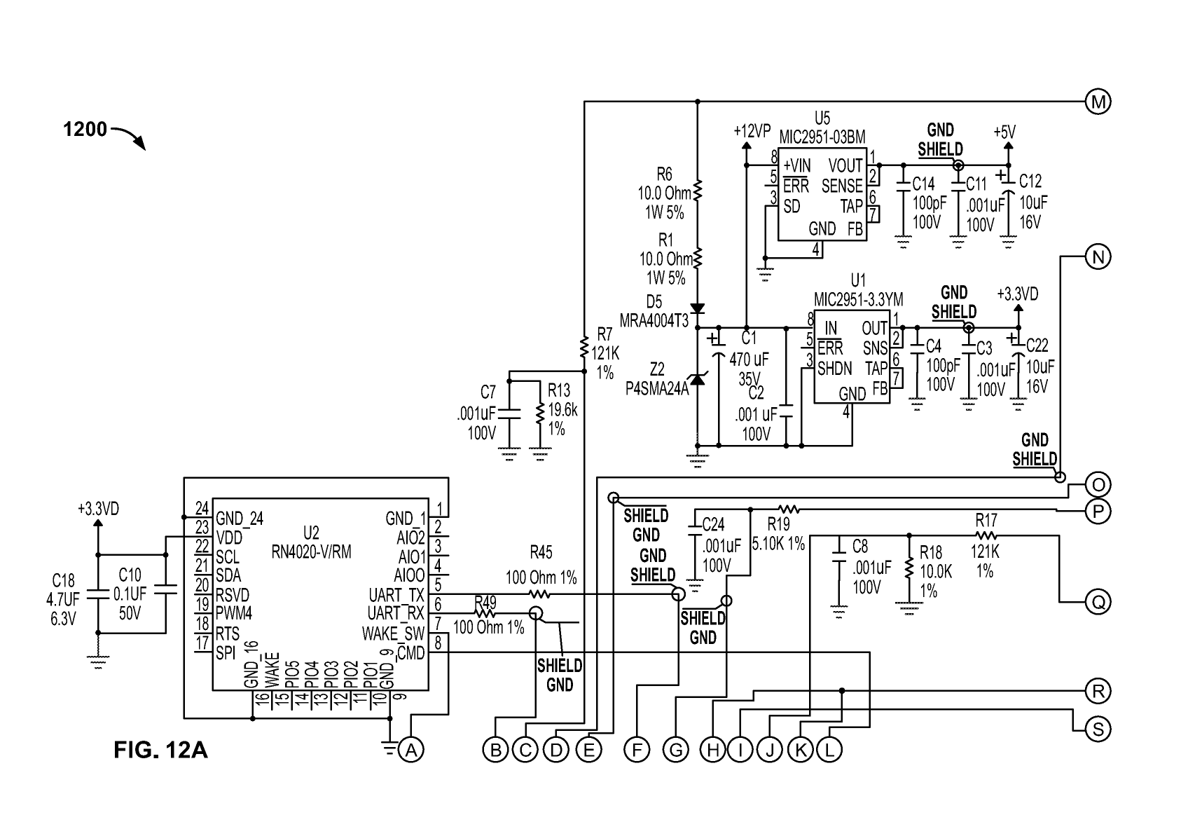

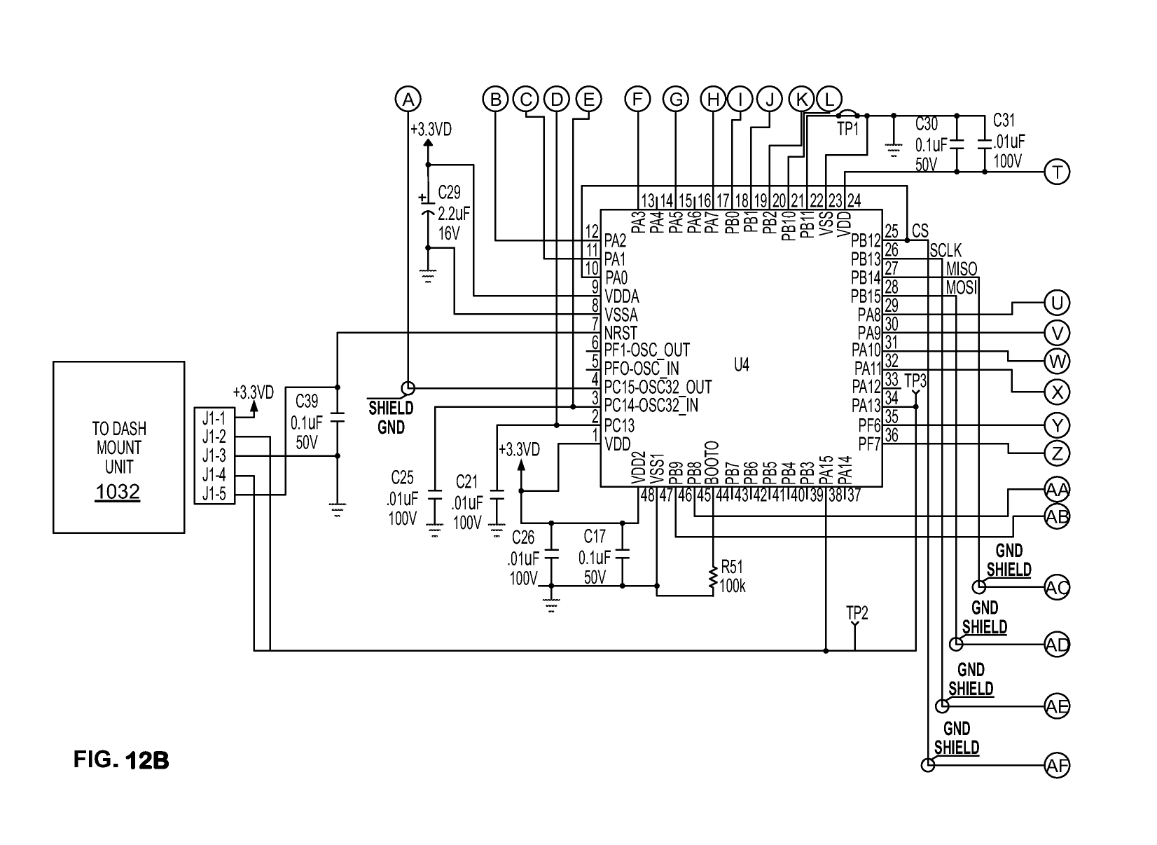

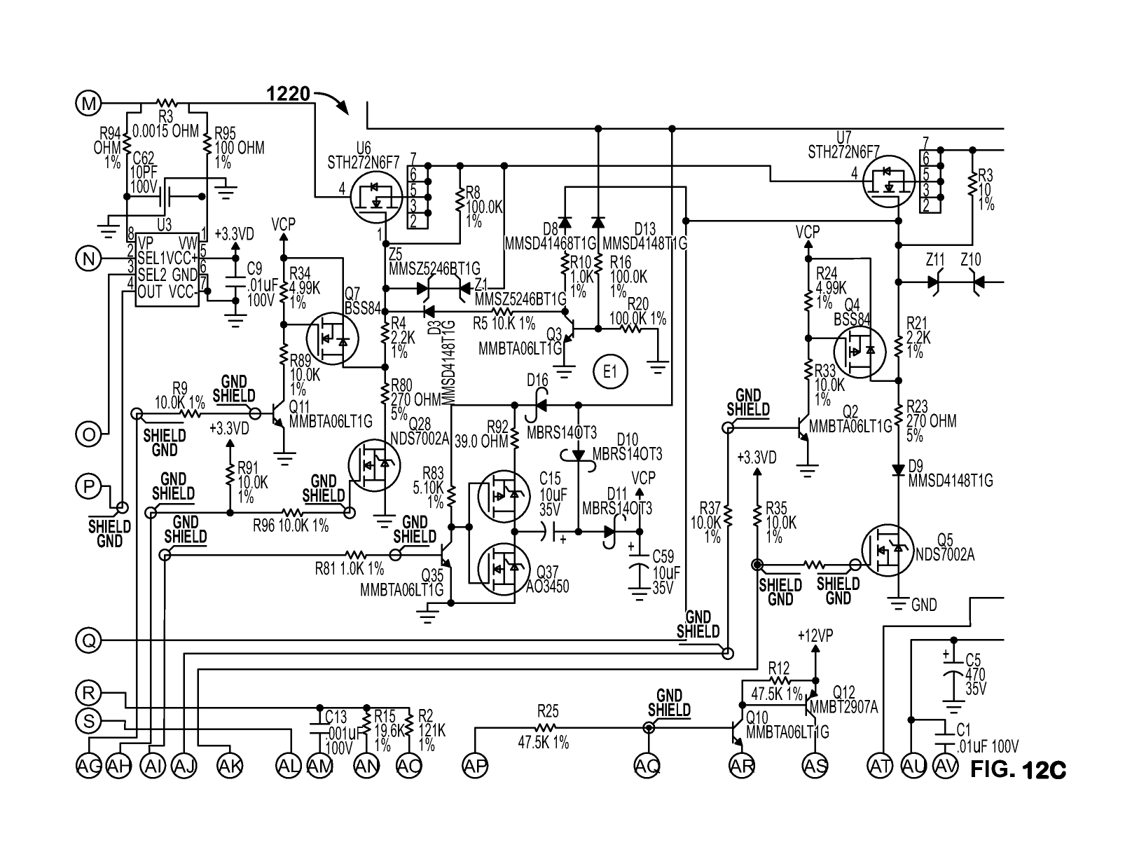

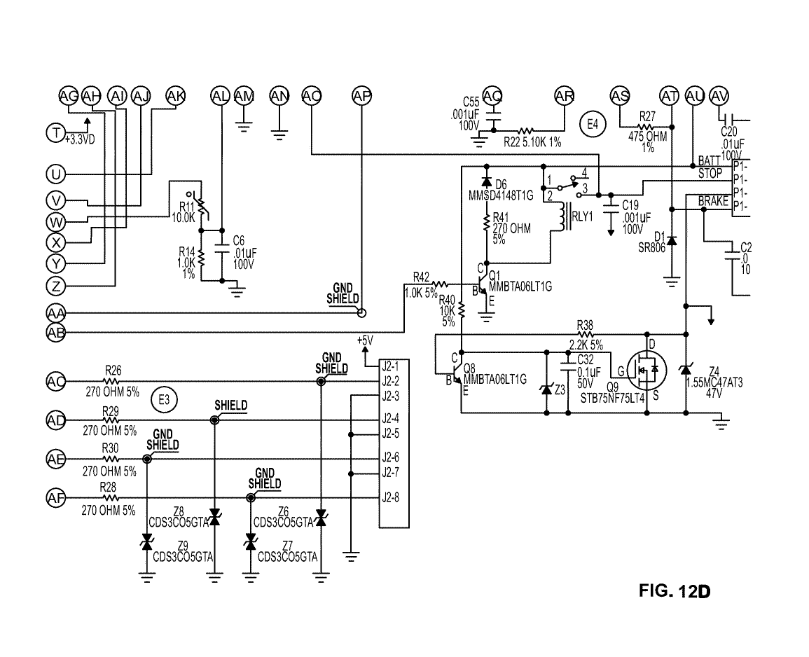

FIGS. 12A and 12B are a schematic diagram for an under dash mount main control circuit 1000 for a brake control unit in accordance with various disclosed embodiments. The under dash mount control circuit 1200 may be operatively connected a dash mount control circuit (e.g., circuit 900) via connection 1032 in accordance with various disclosed embodiments. It is noted that the main control circuit 1200 may comprise a processor that communicates with the processor of the dash mount unit. In another aspect, the control circuit includes a wireless transponder/receiver and power control circuitry. As the main control circuit 1000 does not include an accelerometer it may be mounted in any desired orientation or position.

As the control circuit 1200 does not include an accelerometer as in tradition systems, the mounting position of the control circuit 1200 is not limited. Moreover, the control circuit 1200 may be disposed in a housing. In various embodiments, the control circuit may be positioned behind the dash on the floor, or any other location that is out of the way and generally hidden. This may improve the aesthetics of the overall design as well.

In another aspect, the main control circuit 1200 may include a power circuit 1220. The power circuit may include a power MOSFET used in series with a main MOSFET used to control the output power to trailer brakes. The faults in the output like a short to a power supply (e.g., Vbat), short to a ground for extended period of time, improper gate voltage or the like are detected and will cause the series MOSFET to turn off to eliminate potential problems that would otherwise arise.

The brake control unit uses I²C and will work with any serial communication in the vehicle. It utilizes a serial display driver. Further, the brake control unit can be operatively coupled with any serial bus or fiber to reduce the wires between the components. In various embodiments, an under dash mount unit or a dash mount unit may monitor communication between the under dash mount unit or a dash mount unit. In the event of failure or interrupted communication, at least one of the under dash mount unit or a dash mount unit may control the brakes of the trailer according to predetermined braking patterns, such as a ramping pattern. For instance, a brake control system may enter a timer mode where the brakes are controlled similar to timer brake controllers. The brake control systems may monitor and determine whether communication is restored. If communication is restored, the brake controller may then transition to a proportional brake control operation. In some embodiments, the brake control system may wait until a braking event is not occurring to transition to the proportional brake control operation. It is further noted that the brake control system may generate notifications to identify a change in operation. Notifications may be audible, visual, or audible and visual.

In embodiments, described brake control units may include a sleep function where one or more of the dash mount unit or under dash mount unit enter a sleep mode. A brake control unit may enter the sleep mode upon occurrence of a triggering event, such as a passage of time where one, some or neither manual braking, gain adjustments, boost adjustments, stoplight activation, or accelerometer readings are active. For instance, the brake control unit may monitor inactivity and may enter a sleep mode after g minutes (or other time units) or inactivity, wherein g is a number (e.g., 5, 10, 15, 30, etc.). As an example a driver may stop a towing vehicle and place the vehicle in park. As the towing vehicle remains idle, the brake control unit may measure the time of inactivity of manual braking, gain adjustments, boost adjustments, stoplight activation, or accelerometer activity. Once there is inactivity for 30 minutes, as an example, the brake control unit may enter a sleep mode where functions may be turned off (e.g., display lights, etc.) to conserve power.

It is noted that the brake control unit may exit or wake from the sleep mode upon occurrence of another triggering event, such as activation of user controls (e.g., a manual knob, a gain button, a boost button), accelerometer movement, brake light activation, or the like. In some embodiments, the dash mount unit and the under dash mount unit may enter or exit a sleep mode independently of each other. For instance, activation of user controls may awake the dash mount unit from a sleep mode while the under dash mount unit remains in a sleep mode. In other examples, a single action may wake both the under dash mount and dash mount units, such as activation of a brake light, accelerometer reading, or the like.

The brake control unit includes (BLUETOOTH) communication capabilities. The brake control unit is capable of external setting communication of the trailer information. This may include communicating information related to the trailer to a separate device, such as a smart phone, computer or tablet. The brake control unit may also communicate with other sensors. These sensors may include external sensors on the towing vehicle or the towed vehicles. Examples of such sensors may be as described in U.S. Pat. No. 9,738,125, which is incorporate by reference herein.

The brake control unit includes a single interface knob. The knob includes a display which may display the proportional output. The brake control unit includes a fully settable boost and gain. The brake control unit can automatically set the best or improved boost based on the gain settings. The brake control unit can change or alter the transfer function based on the gain settings.

Modification of the disclosure will occur to those skilled in the art and to those who make or use the invention, including, without limitation, the values provided for the various elements disclosed above. It should be understood that such values are exemplary values and the present invention is not limited to those values. Therefore, it is understood that the embodiments shown in the drawings and described above are merely for illustrative purposes and not intended to limit the scope of the invention, which is defined by the following claims as interpreted according to the principles of patent law, including the Doctrine of Equivalents.

1. A brake control unit for controlling brakes of a towed vehicle comprising:
a dash mount unit comprising:
a body comprising an accelerometer and a processor;
an input device extending from the body; and
a display device disposed within the input device; and
an under dash mount unit communicatively coupled to the dash mount unit and comprising a main control board,
wherein the under dash mount unit is separate from the body of the dash mount unit.

2. The brake control unit of claim 1, wherein the input device comprise a hollow shaft potentiometer.

3. The brake control unit of claim 2, wherein the input device further comprise the hollow shaft potentiometer and a control knob, and wherein the hollow shaft potentiometer is mounted with the control knob.

4. The brake control unit of claim 3, wherein the display device is positioned within the control knob.

5. The brake control unit of claim 4, wherein the display device comprises a dual 7-segment display.

6. The brake control unit of claim 4, wherein the control knob comprises a lens positioned in front of the display device.

7. The brake control unit of claim 3, wherein the control knob comprises a sensor that operatively detects a push of the control knob representing input from a user.

8. The brake control unit of claim 3, wherein the control knob comprises a sensor that operatively detects a turn of the control knob representing input from a user.

9. The brake control unit of claim 1, wherein the dash mount unit comprises a dash mount circuit board, and wherein the accelerometer, the processor, the display, and the input device are coupled to the dash mount circuit board.

10. The brake control unit of claim 1, wherein the dash mount unit is coupled to the under dash mount unit via at least one of a serial peripheral interface bus or an Inter-Integrated Circuit bus.

11. The brake control unit of claim 1, wherein the dash mount unit and the under dash mount unit communicate via an encoded pulse width modulated signal.

12. The brake control unit of claim 1, wherein the main control board comprises a power circuit that operatively sends power to trailer brakes.

13. The brake control unit of claim 12, wherein the power circuit comprises a main MOSFET and a power MOSFET in series with the main MOSFET.

14. The brake control unit of claim 13, wherein the power MOSFET is switched to an off condition in response to detection of a short, improper connection, or improper gate voltage.

15. A brake control unit comprising:
a dash mount unit comprising:
a body comprising an accelerometer and a processor;
an input device comprising a hollow shaft potentiometer and a control knob extending from the body, wherein the control knob is rotatable; and
a display device disposed within the control knob; and
an under dash mount unit communicatively coupled to the dash mount unit and comprising a main control board,
wherein the under dash mount unit is separate from the body of the dash mount unit, and
wherein the display device maintains its orientation while the control knob is operatively rotated.

16. The brake control unit of claim 15, wherein the under dash mount unit is operatively installable in any orientation.

17. A brake control unit comprising:
a dash mount unit comprising:
a body comprising an accelerometer and a processor;
an input device comprising a hollow shaft potentiometer and a control knob extending from the body, wherein the control knob is rotatable; and
a display device disposed within the control knob; and
an under dash mount unit communicatively coupled to the dash mount unit and comprising a main control board,
wherein the main control board comprises a power circuit that operatively sends a control signal to brakes of a towed vehicle, and wherein the main control board determines whether the main control board and the body are in operative communication.

18. The brake controller of claim 17, wherein the main control board sends the control signal is a proportional control signal when the main control board determines that the main control board and the body are in operative communication.

19. The brake controller of claim 17, wherein the main control board sends the control signal is a predetermined ramping control signal when the main control board determines that the main control board and the body are not in operative communication.

20. The brake controller of claim 17, wherein at least one of the dash mount unit or under dash mount unit operatively enter a sleep mode in response to at least one of a passage of time where manual braking is not activated, gain adjustments are not activated, boost adjustments are not activated, a stoplight is not activated, or an accelerometer readings is inactive.

21. The brake controller of claim 20, wherein at least one of the dash mount unit or under dash mount unit operatively exits the sleep mode upon activation of manual braking, gain adjustments, boost adjustments, stoplight activation, or accelerometer readings.
